(19) United States
(12) Patent Application Publication
(10) Pub. No.: US 2015/0193786 A1
(43) Pub. Date: Jul. 9, 2015

(54) COMPUTATION OF A MOBILE SUBSCRIBER'S SOCIAL RANK TO INDICATE IMPORTANCE

(71) Applicant: Tektronix, Inc., Beaverton, OR (US)

(72) Inventors: Colm Costelloe, Dublin (IE); Manuel Stopnicki, Beaverton, OR (US)

(73) Assignee: TEKTRONIX, INC., Beaverton, OR (US)

(21) Appl. No.: 14/590,638

(22) Filed: Jan. 6, 2015

Related U.S. Application Data
(60) Provisional application No. 61/924,329, filed on Jan. 7, 2014.

(51) Int. Cl. G06Q 30/02; G06Q 50/00; G06F 17/30; H04W 8/18

(52) U.S. Cl. CPC G06Q 30/0201; H04W 8/186; G06Q 50/01; G06F 17/30864

(57) ABSTRACT

A method and system for providing information related to a social rank of a subscriber in a telecommunication network in which information is collected related to one or more subscribers from the telecommunication network. A direct relationship is determined between a subscriber and a first plurality of subscribers in the telecommunication network and an indirect relationship is determined between the subscriber and a second plurality of subscribers in the telecommunication network, wherein the subscriber and the second plurality of subscribers are members of the same social network. A social rank indicator is then generated corresponding to the subscriber based on the direct relationship between the subscriber and the first plurality of subscribers and based on the indirect relationship between the subscriber and the second plurality of subscribers.

### CROSS REFERENCE TO RELATED APPLICATIONS

This application claims priority to U.S. Patent Application Ser. No. 61/924,329 filed on Jan. 7, 2014 which is incorporated herein by reference in its entirety.

### FIELD OF THE INVENTION

The present invention relates generally to mobile communications and, more particularly, to providing a social ranking of a terminal user in a telecommunication network.

### BACKGROUND OF THE INVENTION

Analyzing users in a communications network to determine rank of the users in terms of a social network based on executed communications (their “social rank”) is known. For example, if a particular user is ranked relatively high in a group of socially related users, it can be assumed that the highly ranked user and his/her service usage will be relatively influential to other users in the group, and it is therefore likely that services consumed by that user can be potentially attractive to the other users as well. Thereby, information on the rank of one user of interest can be useful for selecting or creating relevant services for other users socially related to that user.

However, there currently exists no efficient procedure or method which can provide a sufficiently truthful social ranking of terminal users in a telecommunication network relative to social networks. It is also a problem that the total number of more or less socially related users in a telecommunication network is typically large, often in the range of many thousands and even millions, thus making calculation of individual user ranks quite complicated and resource-demanding. For example, a cluster of socially related users which are linked to each other by having executed sessions, implying a great number of direct and indirect social relations, may be quite large.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, a method and system for providing information related to a social rank of a subscriber in a telecommunication network is described in which information is collected related to one or more subscribers from the telecommunication network. A direct relationship is determined between a subscriber and a first plurality of subscribers in the telecommunication network and an indirect relationship is determined between the subscriber and a second plurality of subscribers in the telecommunication network, wherein the subscriber and the second plurality of subscribers are members of the same social network. A social rank indicator is then generated corresponding to the subscriber based on the direct relationship between the subscriber and the first plurality of subscribers and based on the indirect relationship between the subscriber and the second plurality of subscribers.

### BRIEF DESCRIPTION OF THE DRAWINGS

The accompanying appendices and/or drawings illustrate various, non-limiting, examples, inventive aspects in accordance with the present disclosure:

FIG. 1 illustrates an example communication network in accordance with an illustrated embodiment;

FIG. 2 is a schematic diagram of the communication network illustrated in FIG. 1 indicating layered stacked protocols of the various component interfaces in both signaling and user data planes;

FIG. 3 is a first exemplary directed graph representing relationships between subscribers in accordance with an embodiment of the present invention;

FIG. 4 is a second exemplary directed graph illustrating how a social rank for each subscriber can be generated based on the subscriber's direct and indirect relationships in accordance with an embodiment of the present invention;

FIG. 5 is a flow diagram of operational steps of the customer care manager (CCM) program of FIG. 1 in accordance with an illustrative embodiment of the present invention; and

FIG. 6 illustrates internal and external components of server computer of FIG. 1 in accordance with an illustrative embodiment of the present invention.

### DETAILED DESCRIPTION OF CERTAIN EMBODIMENTS

The present invention is now described more fully with reference to the accompanying drawings, in which illustrated embodiments of the present invention is shown wherein like reference numerals identify like elements. The present invention is not limited in any way to the illustrated embodiments as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may differ from the actual publication dates which may need to be independently confirmed.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims.

As used herein, the term “subscriber” refers to a user of a mobile device or a user equipment (UE) for communicating in the mobile telecommunications network.

A telecommunications network is a geographically distributed collection of nodes interconnected by communication links and segments for transporting data between end nodes, such as smart phones, pads, personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. Various embodiments of the present invention will now be described, by way of example only, and with reference to GPRS EDGE network architecture.

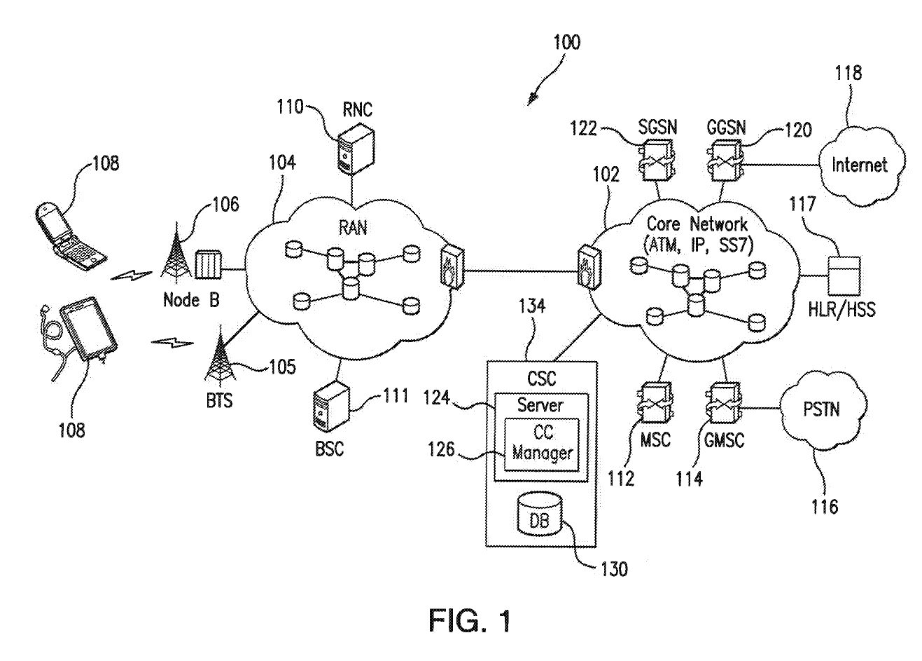

FIG. 1 is a high level diagram of an example mobile telecommunications network 100, in which an embodiment of the present invention may be implemented. The mobile telecommunications network 100 architecture includes a core network 102 interconnected with a Radio Access Network (RAN) 104 via an interface known as IU which is defined in detail in the current publicly available 3GPP (Third Generation Partnership Project) specification documents. In the exemplary environment illustrsted in FIG. 1, the radio part 104 of the mobile telecommunications network 100 comprises one or more GERANs 104 (GSM/EDGE Radio Access Networks) coupled with one or more UTRANs (Universal Terrestrial Radio Access Networks) which is a part of a Universal Mobile Telecommunications System (UMTS). The standards for GERAN and UTRAN are maintained by the 3GPP. It is to be further appreciated that the foregoing configuration is purely illustrative, and various implementations may include other cellular technologies, such as, WCDMA (Wideband Code Division Multiple Access), CDMA2000, CDMA 1x EVDO, LTE-A (Long Term Evolution-Advanced), and the like in various combinations.

The RAN 104 is configured to provide wireless telecommunication services to subscribers through UEs 108 via a radio interface known as UU. The UMTS part of the RAN 104 has base stations, known as NodeBs 106, while the GSM part has base stations known as BTSs (Base Transciever Stations) in 3GPP, which collectively provide for the geographic coverage for wireless communications with UEs 108. In the UMTS part of RAN 104, groups of one or more NodeBs 106 are connected to a Radio Network Controller (RNC) 110 via an interface known as Iub in 3GPP. The RAN 104 may have several groups of NodeBs 106 connected to different RNCs 110, only one of which is shown in the example depicted in FIG. 1. Where more than one RNCs 110 are provided in a RAN 104, inter-RNC 110 communication is preferably performed via the Iub interface. In the GSM part of RAN 104, groups of one or more BTSs 105 are connected to a Base Station Controller (BSC) 111. A BSC 111 controls a group of BTSs 105 connected to it via the A-bis interface. It is noted, while the embodiments are described herein with reference to a combined UMTS/GSM network architecture, the description herein is not so limited, and may be applied to a variety of networks and interfaces.

UEs 108 typically have a home network (HN) with which it is registered and through which billing and other functions are processed. Under current 3GPP specifications, the core network 102 of a UE's 108 HN serves to coordinate and process the functions of Authentication, Authorization and Accounting (AAA functions). When a UE 108 travels beyond its HN, the HN's core network 102 facilitates the UE's 108 use of a Foreign Network (FN) by being able to coordinate the AAA functions so that the FN will permit the UE 108 to conduct communications. To assist in implementing this activity, the core network 104 includes a Home Location Register (HLR) 117 which tracks the UEs 108 for which it is the HN. A Home Service Server (HSS) is provided in conjunction with the HLR 117 to process the AAA functions.

Under current 3GPP specifications, the core network 102, and preferably not the RAN 104, is configured with connectivity to external systems such as Public Land Mobile Networks (PLMN), Public Switch Telephone Networks (PSTN) 116, Integrated Services Digital Network (ISDN) and other Real Time (RT) services via an RT service interface. Core network 102 will also support Non-Real Time (NRT) services with the Internet 118. Under current 3GPP specifications, the core network 102 provides RT service external connectivity via a Gateway Mobile Switching Center (GMSC) 114. The core network 102 preferably provides NRT service, known as General Packet Radio Service (GPRS), external connectivity via a Gateway GPRS Support Node (GGSN) 120. In this context, a particular NRT service may actually appear to a subscriber to be a real time communication due to the communication speed and associated buffering of the Time Division Duplex (TDD) data packets forming the communication. One example of this is voice communication via the Internet 118 which can appear to the subscriber as a normal telephone call conducted by a switching network, but is actually being conducted using an Internet Protocol (IP) connection which provides packet data service.

To provide support for both RT and NRT services from external sources for radio linked UEs 108 in a 3GPP system, the RAN 104 typically needs to interface with the CN 102, which is the function of the Iu interface. To enable this communication, the core network 102 typically includes a Mobile Switching Center (MSC) 112 that is coupled to the GMSC 114 and a Serving GPRS Support Node (SGSN) 122 that is coupled to the GGSN 120.

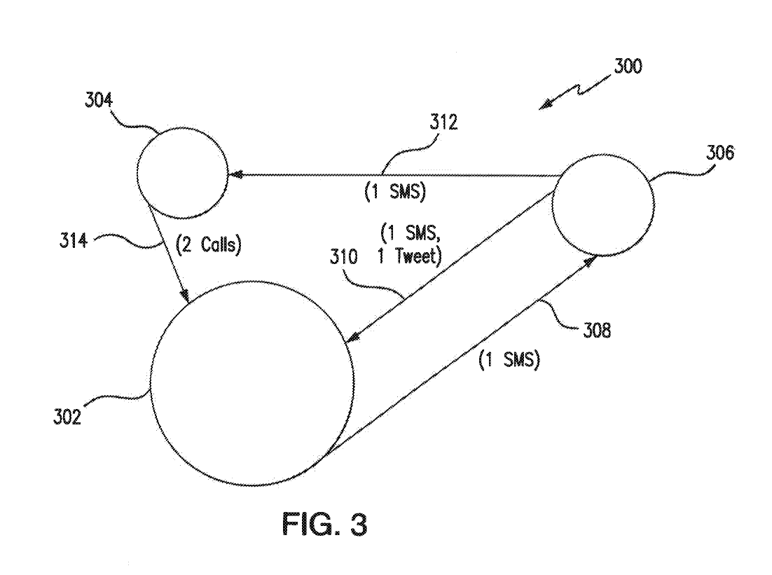

Customer experience management is an important operational scheme for service providers. Thus, service providers typically maintain a Customer Service Center (CSC) 134 to provide support to the users of UEs 108 (subscribers) and/or to monitor the network 100. According to an embodiment of the present invention, CSC 134 may include a variety of customer service systems. One of the customer service systems may include, but not limited to a server 124 which may be communicatively connected to the core network 102. In an embodiment of the present invention, server 124 may comprise, or otherwise may cooperate with a customer care manager (CCM) software program 126. CCM 126 may be, for example, a computer program or program component capable of collecting certain information about each mobile subscriber and configured to determine the relative importance of the mobile subscriber, based on the collected information. Currently, in the context of a mobile service providers customer experience management a few typical metrics are used to determine the relative importance of a subscriber, such as subscriber's relative ARPU (i.e., billing revenue from the subscriber), the subscriber's relative usage (i.e., number of calls, messages, data transactions), the subscriber's statically provisioned information (i.e., VIP billing type, corporate billing type, etc.). However, the aforementioned metrics fail to take into account the so called “networking effects”. In other words these metrics are not indicative of interactions between a plurality of subscribers. Advantageously, CCM 126 is preferably configured to provide an additional social rank metric associated with a mobile network subscriber, as described below in conjunction with FIGS. 3-5. Data gathered, generated, and maintained for use by the CCM 126 may be kept in the internal storage of the server 124 or in one or more databases 130 of the CSC 134.

It is noted that the UEs 108 are depicted in FIG. 1 as a mobile wireless device such as a cell phone or smart phone. However, it may be any portable device, such as a laptop, notebook, tablet computer, palm-sized computer, or any electronic device with capability to receive communication (i.e. wireless) signals.

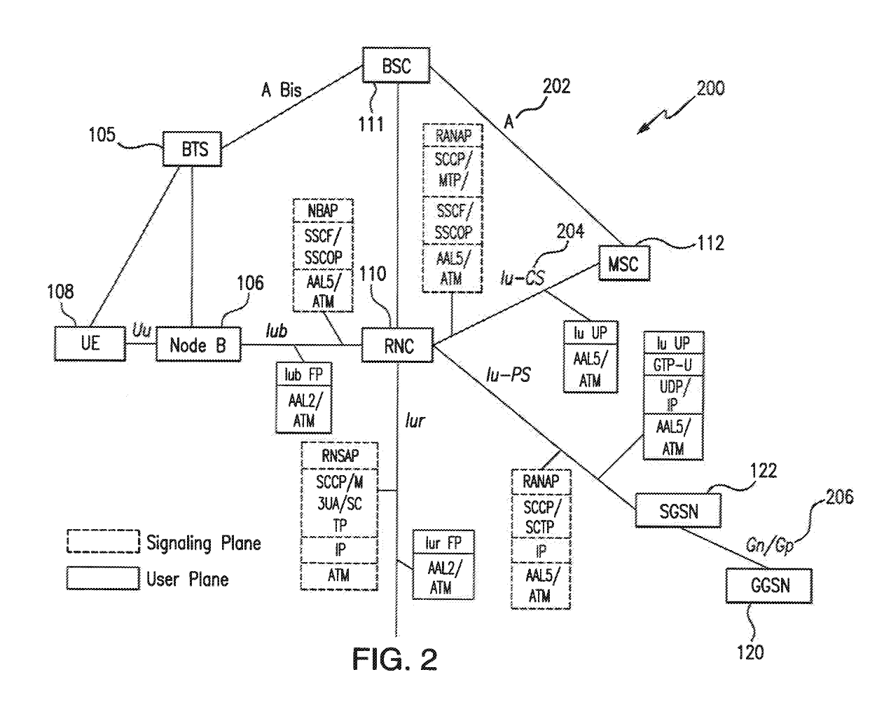

FIG. 2 is a schematic diagram of the exemplary communication network illustrated in FIG. 1 indicating layered stacked protocols of the various component interfaces in both signaling and user data planes. The RAN 104 segment of the combined UMTS/GSM network architecture is preferably split into two traffic planes known as the C- and U-planes. The C-plane carries control (signaling) traffic, and the U-plane transports user data. The over-the-air segment of the RAN 104 involves two interfaces: the Uu interface between UE 108 and NodeB 106, and the Iub interface between the NodeB 106 and RNC 110. As noted above, the back-end interface between the RNC 110 and core network 102 is referred to as the Iu interface, split into the Iu-CS 204 for the circuit-switched (CS) connection into the MSC 112, and the Iu-PS for the packet-switched connection into the SGSN 122.

The HLR/HSS 117 is typically interfaced with the CS side of the core network 102, MSC 112 and GMSC 114 via an interface known as Gr which supports AAA functions through a Mobile Application Part (MAP) Protocol. The SGSN 122 and the GGSN 120 of the CN are connected using interfaces known as Gn and Gp 206.

One of the most significant signaling protocols on the over-the-air segment of the RAN 104 is Radio Resource Control (RRC). RRC manages the allocation of connections, radio bearers and physical resources over the air interface. In 3GPP, RRC signaling is carried over the Radio Link Control (RLC) and Medium Access Control (MAC) UMTS protocols between the UE 108 and RNC 110. Overall, the RNC is responsible for the allocation/de-allocation of radio resources, and for the management of key procedures such as connection management, paging and handover. Over the Iub interface, RRC/RLC/MAC messaging is typically carried on a Transport Layer via Asynchronous Transfer Mode (ATM), using the ATM Adaptation Layer Type 5 (AALS) protocol over the ATM physical layer with intermediary protocols, such as Service Specific Coordination Function (SSCF) and the Service Specific Connection Oriented Protocol SSCOP, being used above AALS. The A-interface 202 is defined in 3GPP as the terrestrial interface between the MSC 112 and the BSS segment of the RAN 104, more specifically BSC 111.

U-plane data (e.g. speech, packet data, circuit-switched data) uses the RLC/MAC layers for reliable transfer over the air interface (between UE 108 and RNC 110). Over the Iub segment, this data flow (user data/RLC/MAC) occurs over UMTS-specified frame protocols using the ATM Adaptation Layer Type 2 (AAL2) protocol over the ATM physical layer running (AAL2/ATM). In this context, a protocol consists of a set of rules defining how the nodes interact with each other.

Those skilled in the art will understand that any number of nodes, devices, links, etc. may be used in the computer network, and that the views shown in FIGS. 1 and 2 are for simplicity. Also, while the embodiments are shown herein with reference to combined UMTS/GSM network 100 architecture, the description herein is not so limited, and may be applied to a variety of networks such as LTE (4 g), WCDMA, CDMA2000, CDMA 1x EVDO, and the like. For purposes of the present patent application, the RAN 104 may be implemented in any combination of known or heretofore unknown radio access technology and network protocols. The RAN 104 can also be an aggregation of channels from multiple bands in the radio access technology LTE-A. LTE-A is a set of enhancements to the UMTS that includes an all-IP networking architecture and the ability of each NodeB to connect to multiple core networks.

As will be appreciated by one skilled in the art, various embodiments of the present invention contemplate that CCM 126 may utilize various call, messaging and/or data transaction records to collect information related to mobile subscribers' interactions with each other in order to determine a subscriber's social rank indicator. In one embodiment, this information may be represented by a directed graph. FIG. 3 depicts a first exemplary directed graph 300 representing social relationships between subscribers in accordance with an embodiment of the present invention. In FIG. 3, each of a plurality of nodes 302-306 represents individual mobile network subscribers and each of a plurality of edges 308-314 represents actual social relationships between the individual subscribers. The edges 308-314 have a direction associated with them. As a non-limiting example, first exemplary graph 300 graphically illustrates that during a pre-determined period of time a second subscriber 304 called a first subscriber 302, for instance, two times (represented by edge 314). The first exemplary graph 300 further illustrates text messaging communications between the subscribers, represented by edges 308, 310 and 312. In addition, the first exemplary graph 300 may include social network related information, such as a social network post referencing a particular subscriber. For instance, edge 310 shows that the third subscriber 306 made a reference related to the first subscriber 302 in a Twitter post. According to an embodiment of the present information, CCM 126 may gather information presented in FIG. 3 by using various interfaces described above as passive probing data sources.

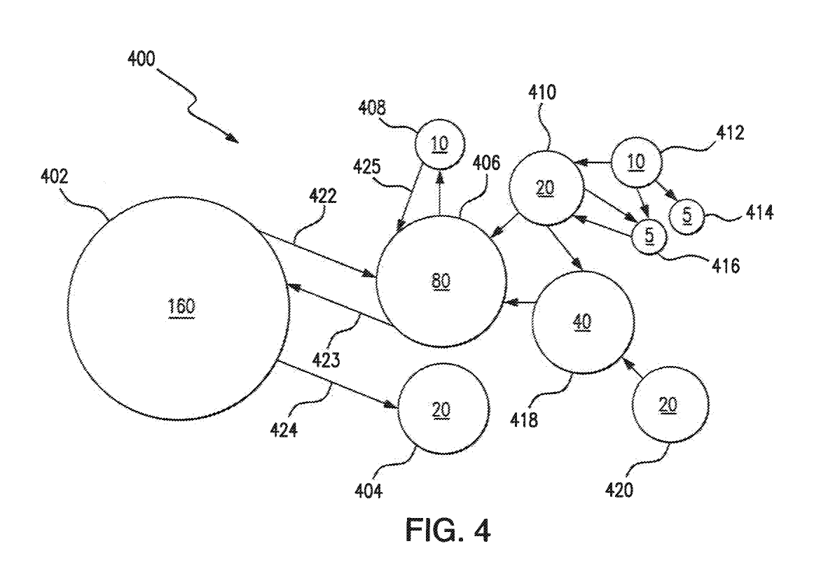

FIG. 4 is a second exemplary directed graph 400 illustrating how a social rank for each subscriber can be generated based on the subscriber's direct and indirect relationships in accordance with an embodiment of the present invention. The second exemplary graph 400 depicts a relatively larger set of subscribers, represented by nodes 402-420 and their social relationships represented by edges, such as edges 422-425. It is noted that the second exemplary graph 400 includes both the direct social relationships and indirect social relationships. For instance, a first subscriber 402 may have a direct relationship with a third subscriber 406 if the first subscriber calls (represented by edge 422) the third subscriber 406. Similarly, the first 402 and third 406 subscribers may have a direct relationship with each other if the third subscriber 406 sends a multi-media message (MMS) to the first subscriber 402, represented by edge 423. The third subscriber 406 may be connected to a plurality of other subscribers 408, 410, 418, 420 via a social network, such as Linkedin. A fifth subscriber 410 may have LinkedIn connections with subscribers 412, 416, and so on. In this illustrative case, the first subscriber 402 has indirect social relationships with members of third subscriber's social network (i.e. subscribers 408-420).

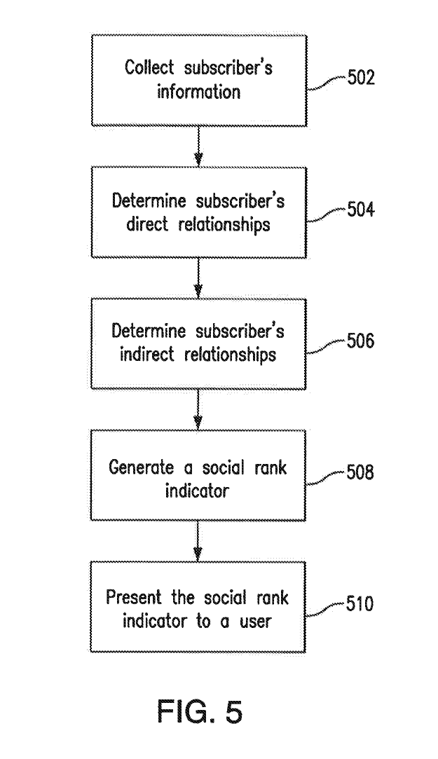

In an embodiment of the present invention, the second exemplary graph 400 representing social relationships between subscribers is preferably a weighted graph. In other words, at least in one implementation CCM 126 may assign weights to each edge, such as edges 422-425. This weight may be used by CCM 126 to represent, for example, degree of mobility, traffic volumes, and the like. After assigning weights to edges 422-425, advantageously, CCM 126 preferably generates a social rank indicator by traversing the directed graph 400, using graph traversing techniques well-known in the art. Exemplary social rank indicator values corresponding to a plurality of nodes 402-420 are shown in FIG. 4, inside each node 402-420. For example, first subscriber 402 may have a corresponding social rank indicator value equal to 160, while the fifth subscriber 410 may have a corresponding social rank indicator value equal to 20. Additional details regarding the generation of social rank indicators are further discussed below in conjunction with FIG. 5.

FIG. 5 is a flow diagram of operational steps of the CCM program 126 of FIG. 1 in accordance with an illustrative embodiment of the present invention. CCM 126 may be, for example, a computer program or program component capable of collecting certain information about each mobile subscriber and configured to determine the relative importance of the mobile subscriber, based on the collected information, using a variation of a page rank algorithm. One well-known page rank algorithm is that used by the popular Web search engine Google. Google's page rank algorithm relies on information about how frequently a document is referenced (linked to) from other documents. The rationale is that a document that is “linked to” by lots of other documents must be interesting, so its rank is increased as the number of such external references increases. In an embodiment of the present invention, CCM 126 subscriber's social rank is increased as the number of direct and indirect relationships increases.

At 502, CCM 126 preferably collects information related to each subscriber using a plurality of passive probing data sources. The plurality of data sources may include, but not limited to, subscriber records, call data records, SMS data records, user-plane API (Application Programming Interface) calls, and the like. The subscriber record typically holds information such as International Mobile Subscriber Identity (IMSI), Mobile Station International ISDN Number (MSISDN) and subscriber key. Whenever UEs 108 make or receive a call for example in a UMTS radio network, signaling messages are exchanged between Node Bs 106 and RNCs 110 over Iub interfaces (shown in FIG. 2) and, for some calls, between RNCs 110 over Iur interfaces (shown in FIG. 2). RNCs 110 and Node Bs 106 make up the UTRAN portion of RAN 104 comprising a UMTS/GSM network. Accordingly, a monitor or probe (not shown in FIG. 1) may be coupled to Iub, Iur and Iu-CS interfaces 204 in the UTRAN. With regards to a GSM portion of the UMTS/GSM network a monitor or probe may be coupled to A interface 202, through which signaling messages are exchanged between MSC 112 and BSC 111. Also, while the embodiments are shown herein with reference to combined UMTS/GSM network 100 architecture, the description herein is not so limited, and may be applied to a variety of networks such as LTE (4 g), IP Multimedia core network Subsystem (IMS), and the like. Monitoring probes implemented in LTE network may connect to, for example, a voice over long term evolution (VoLTE) interface, while in IMS environment, monitoring probes may be coupled to Session Initiation Protocol (SIP) based IMS interface. Monitoring probes non-intrusively coupled to one of the above mentioned interfaces preferably capture substantially all of the protocol messages traveling across these interfaces. In addition monitoring equipment may identify the messages belonging to each voice or data call and correlate those messages into one call record per call, one SMS record per SMS message, and so on.

At 504, CCM 126 preferably determines a set of direct social relationships between the plurality of subscribers. In an embodiment of the present invention direct social relationships may comprise voice calls, SMS messages, MMS (Multimedia Messaging Service) messages, and the like. For instance, referring back to FIG. 3, if a second subscriber 304 called a first subscriber 302, CCM 126 may use the corresponding voice call obtained by monitoring one of the interfaces, such as A interface 202, IuCS 204, VoLTE, SIP IMS, and the like, to identify a direct relationship between the first subscriber 302 and the second subscriber 304. Similarly, CCM 126 may identify a direct social relationship between two subscribers if they exchange one or more MMS messages with each other. Information related to MMS messages may be obtained by monitoring, for example, Gn interface 206 in UMTS/GSM network architecture or S5 interface in LTE environment. In an embodiment of the present invention, CCM 126 may represent the correlations as a directed graph, such as, for example, second exemplary graph 400 depicted in FIG. 4.

Next, at 506, CCM 126 preferably determines a set of indirect social relationships between the plurality of subscribers. In an embodiment of the present invention indirect social relationships may comprise subscriber's social network friends/followers and other social networks connections. Typically, for GPRS control plane packets such as session creation requests arriving on a Gn 206 or S5 (or S8) interface are sent to an anchor session Dense Port Concentrator (DPC) (not shown in FIG. 2) for processing. The session DPC load-balances and selects anchor interface DPCs or Modular Port Concentrators (MPCs) (housing the Packet Forwarding Engines) for the user session, and all subsequent data packets for that session flow through the anchor Packet Forwarding Engine. Accordingly, using a DPC configuration on the Gn 206 and/or S5 interface, CCM 126 may identify, for example, subscriber's Twitter user_id and screen_name values and read the subscriber's IMS/MSISDN at the same time. In an embodiment of the present invention, CCM 126 may utilize, for example RESTful API as a mechanism to correlate subscriber ids (i.e. IMSI/MSISDN) to Twitter's user id, as well as the subscriber's Twitter relationships. Representational State Transfer (REST) is a software architecture style used for identifying, manipulating and transferring resource states through communication sessions. REST is stateless and is typically based on Hypertext Transfer Protocol (HTTP). Computing devices, such as UEs 108, might use a RESTful protocol for various other services.

As another non-limiting example, using a DPC configuration on the Gn 206 and/or S5 interface, CCM 126 may identify subscriber's Facebook user_name value and read the subscriber's IMS/MSISDN at the same time. In another embodiment of the present invention, CCM 126 may use the Facebook Graph API (FGA) to retrieve information about connections between the subscriber and his/her Facebookfriends. While the embodiments are described herein with reference to Twitter and Facebook social networks, the description herein is not so limited, and may be applied to a variety of social networks such as, but not limited to, LinkedIn, Google+, Flickr and the like. Again, CCM 126 may represent the indirect correlations as a directed graph, such as, for example, second exemplary graph 400 depicted in FIG. 4

As a preferable embodiment of the present invention, step 504 may further comprise obtaining rules regarding accessibility of said subscribers' indirect social relationships information, where these rules may be set, for example, by a service provider. This enables the service provider to limit the access to subscribers' potentially private information. For example, CCM 126 may not be able to identify, for example, friends of friends of a particular subscriber. The preferable embodiment of the present invention contemplates other types of privacy related restrictions.

Next, at 508, CCM 126 preferably generates a social rank indicator corresponding to each of the plurality of subscribers, such as subscribers 402-420 shown in FIG. 4. In an embodiment of the present invention, CCM 126 may traverse the directed graph, for example second exemplary directed graph 400, by following a route between nodes 402-420 and along edges, such as edges 422-425, of the directed graph 400, using techniques known in the art. As previously indicated, a weight may be assigned to each edge by CCM 126 based on a variety of factors, such as, degree of mobility, traffic volume, among other factors. Furthermore, CCM 126 may assign additional weighting factor to each relationship type (edge of the directed graph) depending on their importance/cost. For example, long voice calls, short voice calls, SMS messages, MMS messages may have a corresponding weight assigned to each category. According to an embodiment of the present invention, for a given subscriber, CCM 126 may generate a corresponding social rank indicator using the following formula (a variation of a well-known page rank algorithm):

SR(A)=(1−d)+d(SR(T₁)/C(T₁)+ . . . +SR(Tₙ)/C(Tₙ))

where SR(A) represents the social rank indicator of subscriber A, SR(Tᵢ) represents the social rank indicators of subscribers Tᵢ which link to subscriber A, C(Tᵢ) represents the number of outbound relationship connections on subscriber Tᵢ, d represents a damping factor which can be set between 0 and 1. It is noted that a social rank indicator for a particular node is proportional to the number of edges (direct and indirect relationships with other subscribers) pointing to the particular node. It is to be further understood that the damping factor value in the above formula may be selected to indicate how much weight CCM 126 should apply to secondary links. Referring back to FIG. 4, if, for example, the weight of a first connection 422 between the first subscriber 402 and the third subscriber 406 is W₁ and the weight of a second connection 425 between the third subscriber 406 and the fourth subscriber 408 is W₂ then, in some embodiments, CCM 126 may determine the overall weight of the path between the first subscriber 402 and the fourth subscriber 408 to be equal to W₂+d*W₁, where d represents a damping factor.

With reference back to FIG. 5, at 510, CCM 126 may present to a user the generated social rank indicator corresponding to a given subscriber. As a non-limiting example, the user may be a customer service representative who received a call from the given subscriber. The social rank of the subscriber may be used by the customer service representative to determine whether and/or how to provide one or more services to that particular subscriber. For instance, if the subscriber requests a replacement UE device, the customer service representative may decide to ship the replacement device free of charge, based on the subscriber's social rank indicator. In addition, one or more customer care applications configured to calculate a subscriber's churn propensity (i.e. likelihood that they will migrate to a different carrier) may utilize the subscriber's social rank indicator generated by CCM 126 at 508 to determine whether any action should be taken to try to prevent the churn. Accordingly, in various embodiments of the present invention, CCM 126 may be configured to cooperate with a variety of customer service systems running within the CSC 134 depicted in FIG. 1.

The flowchart and block diagram in the FIG. 5 illustrates the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

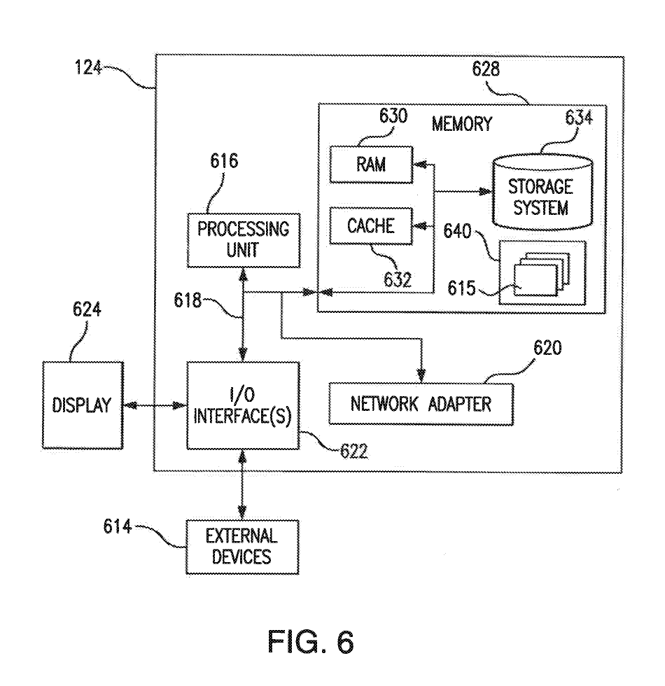

FIG. 6 is a schematic block diagram of an example server 124 that may be used (or components thereof) with one or more embodiments described herein. The server 124 is only an example of a suitable server computer and is not intended to suggest any limitation as to the scope of use or functionality of embodiments of the invention described herein. Regardless, the server 124 is capable of being implemented and/or performing any of the functionality set forth hereinabove.

Server 124 is operational with numerous other general purpose or special purpose computing system environments or configurations. Examples of well-known computing systems, environments, and/or configurations that may be suitable for use with server 124 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed data processing environments that include any of the above systems or devices, and the like.

Server 124 may be described in the general context of computer system-executable instructions, such as program modules, being executed by a computer system. Generally, program modules may include routines, programs, objects, components, logic, data structures, and so on that perform particular tasks or implement particular abstract data types. Server 124 may be practiced in distributed data processing environments where tasks are performed by remote processing devices that are linked through the telecommunication network 100. In a distributed data processing environment, program modules may be located in both local and remote computer system storage media including memory storage devices.

Server 124 is shown in FIG. 6 in the form of a general-purpose computing device. The components of server 124 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Server 124 typically includes a variety of computer system readable media. Such media may be any available media that is accessible by server 124, and it includes both volatile and non-volatile media, removable and non-removable media.

System memory 628 can include computer system readable media in the form of volatile memory, such as random access memory (RAM) 630 and/or cache memory 632. Server 124 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the invention.

Program/utility 640, having a set (at least one) of program modules 615, such as CCM module 126 described above, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 615 generally carry out the functions and/or methodologies of embodiments of the invention as described herein.

Server 124 may also communicate with one or more external devices 614 such as a keyboard, a pointing device, a display 624, etc.; one or more devices that enable a user to interact with server 124; and/or any devices (e.g., network card, modem, etc.) that enable server 124 to communicate with one or more other computing devices. Such communication can occur via Input/Output (I/O) interfaces 622. Still yet, server 124 can communicate with one or more networks such as a local area network (LAN), a general wide area network (WAN), and/or a public network (e.g., the Internet) via network adapter 620. As depicted, network adapter 620 communicates with the other components of server 124 via bus 618. It should be understood that although not shown, other hardware and/or software components could be used in conjunction with server 124. Examples, include, but are not limited to: microcode, device drivers, redundant processing units, external disk drive arrays, RAID systems, tape drives, and data archival storage systems, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing information related to a social rank of a subscriber in a telecommunication network, the method comprising the steps of:
collecting information related to the subscriber from the telecommunication network;
determining a direct relationship between the subscriber and a first plurality of subscribers in the telecommunication network;
determining an indirect relationship between the subscriber and a second plurality of subscribers in the telecommunication network, wherein the subscriber and the second plurality of subscribers are members of the same social network; and
generating a social rank indicator corresponding to the subscriber based on the direct relationship between the subscriber and the first plurality of subscribers and based on the indirect relationship between the subscriber and the second plurality of subscribers.

2. The method of claim 1, wherein the steps of determining a direct relationship and determining an indirect relationship comprise generating a graph having nodes and edges, wherein each of the nodes represents the subscriber, one of the first plurality of subscribers or one of the second plurality of subscribers and each of the edges represents the direct relationship between the subscriber and one of the first plurality of subscribers or represents the indirect relationship between the subscriber and one of the second plurality of subscribers.

3. The method of claim 1, wherein collecting information related to the subscriber comprises collecting Iu-CS traffic information from a Mobile Switching Center.

4. The method of claim 1, wherein collecting information related to the subscriber comprises collecting VoLTE (Voice-over-LTE) traffic information from a Mobile Switching Center.

5. The method of claim 1, wherein generating a social rank indicator comprises assigning a weighting factor to each of the direct relationships and to each of the indirect relationships.

6. The method of claim 1, wherein generating a corresponding social rank indicator (SR(A)) comprises:
SR(A)=(1−d)+d(SR(T₁)/C(T₁)+ . . . +SR(Tₙ)/C(Tₙ))
where SR(A) represents a social rank indicator of subscriber A, SR(Tᵢ) represents social rank indicators of subscribers Tᵢ which link to subscriber A, C(Tᵢ) represents a number of outbound relationship connections on subscriber Tᵢ, and d represents a damping factor which can be set between 0 and 1.

7. A computer system for determining a social rank of a subscriber in a telecommunication network, comprising:
a memory configured to store instructions;
a processor disposed in communication with said memory, wherein said processor upon execution of the instructions is configured to:
collect information related to the subscriber from the telecommunication network;
determine a direct relationship between the subscriber and a first plurality of subscribers in the telecommunication network;
determine an indirect relationship between the subscriber and a second plurality of subscribers in the telecommunication network, wherein the subscriber and the second plurality of subscribers are members of the same social network; and
generate a social rank indicator corresponding to the subscriber based on the direct relationship between the subscriber and the first plurality of subscribers and based on the indirect relationship between the subscriber and the second plurality of subscribers.

8. The computer system of claim 7, wherein determining a direct relationship and determining an indirect relationship comprise generating a graph having nodes and edges, wherein each of the nodes represents the subscriber, one of the first plurality of subscribers or one of the second plurality of subscribers and each of the edges represents the direct relationship between the subscriber and one of the first plurality of subscribers or represents the indirect relationship between the subscriber and one of the second plurality of subscribers.

9. The computer system of claim 7, wherein collecting information related to the subscriber comprises collecting Iu-CS traffic information from a Mobile Switching Center.

10. The computer system of claim 7, wherein collecting information related to the subscriber comprises collecting VoLTE (Voice-over-LTE) traffic information from a Mobile Switching Center.

11. The computer system of claim 7, wherein generating a social rank indicator comprises assigning a weighting factor to each of the direct relationships and to each of the indirect relationships.

12. The computer system of claim 7, wherein generating a corresponding social rank indicator (SR(A)) comprises:
SR(A)=(1−d)+d(SR(T₁)/C(T₁)+ . . . +SR(Tₙ)/C(Tₙ))
where SR(A) represents a social rank indicator of subscriber A, SR(Tᵢ) represents social rank indicators of subscribers Tᵢ which link to subscriber A, C(Tᵢ) represents a number of outbound relationship connections on subscriber Tᵢ, and d represents a damping factor which can be set between 0 and 1.

13. A non-transitory computer readable storage medium and one or more computer programs embedded therein, the computer programs comprising instructions, which when executed by a computer system, cause the computer system to:
collect information related to the subscriber from the telecommunication network;
determine a direct relationship between the subscriber and a first plurality of subscribers in the telecommunication network;
determine an indirect relationship between the subscriber and a second plurality of subscribers in the telecommunication network, wherein the subscriber and the second plurality of subscribers are members of the same social network; and
generate a social rank indicator corresponding to the subscriber based on the direct relationship between the subscriber and the first plurality of subscribers and based on the indirect relationship between the subscriber and the second plurality of subscribers.

14. The non-transitory computer readable storage medium of claim 13, wherein determining a direct relationship and determining an indirect relationship comprise generating a graph having nodes and edges, wherein each of the nodes represents the subscriber, one of the first plurality of subscribers or one of the second plurality of subscribers and each of the edges represents the direct relationship between the subscriber and one of the first plurality of subscribers or represents the indirect relationship between the subscriber and one of the second plurality of subscribers.

15. The non-transitory computer readable storage medium of claim 13, wherein collecting information related to the subscriber comprises collecting Iu-CS traffic information from a Mobile Switching Center.

16. The non-transitory computer readable storage medium of claim 13, wherein collecting information related to the subscriber comprises collecting VoLTE (Voice-over-LTE) traffic information from a Mobile Switching Center.

17. The non-transitory computer readable storage medium of claim 13, wherein generating a social rank indicator comprises assigning a weighting factor to each of the direct relationships and to each of the indirect relationships.

18. The non-transitory computer readable storage medium of claim 13, wherein generating a corresponding social rank indicator (SR(A)) comprises:
SR(A)=(1−d)+d(SR(T₁)/C(T₁)+ . . . +SR(Tₙ)/C(Tₙ))
where SR(A) represents a social rank indicator of subscriber A, SR(Tᵢ) represents social rank indicators of subscribers Tᵢ which link to subscriber A, C(Tᵢ) represents a number of outbound relationship connections on subscriber Tᵢ, and d represents a damping factor which can be set between 0 and 1.
